(19) United States
(12) Patent Application Publication
(10) Pub. No.: US 2025/0046553 A1
(43) Pub. Date: Feb. 6, 2025

(54) ELECTROMAGNETIC RELAY

(71) Applicant: OMRON Corporation, Kyoto-shi (JP)

(72) Inventors: Hideto YAMAUCHI, Kyoto-shi (JP); Kazuhiro TSUTSUI, Kyoto-shi (JP); Hiroki KAWARASAKI, Kyoto-shi (JP)

(21) Appl. No.: 18/764,378

(22) Filed: Jul. 5, 2024

(30) Foreign Application Priority Data
Jul. 31, 2023 (JP) 2023-124688

(51) Int. Cl. H01H 50/44; H01H 50/54

(52) U.S. Cl. CPC H01H 50/44; H01H 50/54

(57) ABSTRACT

An electromagnetic relay includes a fixed contact, a fixed terminal, a coil, an iron core, and a spool. The fixed terminal includes a contact support portion on which the fixed contact is provided. The coil is disposed behind the fixed terminal. The iron core includes a shaft portion and a head portion. The spool includes a hole and a flange. The shaft portion is disposed in the hole. The flange includes a first front surface and a second front surface. The hole is open at the first front surface. The first front surface is disposed rearward of and facing the head portion. The second front surface is disposed rearward of and facing the contact support portion. The second front surface is spaced a predetermined distance rearward from the first front surface. The predetermined distance is greater than the thickness of the contact support portion in the front-rear direction.

### CROSS-REFERENCE TO RELATED APPLICATION

This application claims priority to Japanese Patent Application No. 2023-124688, filed Jul. 31, 2023. The contents of that application are incorporated by reference herein in their entirety.

### FIELD

The claimed invention relates to an electromagnetic relay.

### BACKGROUND

Some electromagnetic relays include a coil, a spool, an iron core, an armature, a movable piece, and a movable contact. For example, in the electromagnetic relay of Japanese Patent No. 6344282, a coil is wound around a spool. The iron core is inserted into a hole in the spool, with the head portion of the iron core located outside the flange of the spool. The armature is disposed to face the head portion. The armature is connected to a movable piece having a movable contact. The electromagnetic force generated by the coil causes the armature to be attracted to the head portion of the iron core. This causes the movable piece to elastically deform, and the movable contact comes into contact with the fixed contact.

### SUMMARY

In the above-described electromagnetic relay, the head portion of the iron core and the fixed terminal are disposed to face the flange of the spool. Therefore, the insulation distance between the iron core and the fixed terminal is small. This reduces the insulation between the iron core and the fixed terminal. If the fixed terminal is located far away from the head portion, the insulation distance between the iron core and the fixed terminal becomes large. In that case, however, the electromagnetic relay becomes large in size. An object of the claimed invention is to improve the insulation between the iron core and the fixed terminal while suppressing an increase in the size of an electromagnetic relay.

An electromagnetic relay in accordance with the claimed invention includes a fixed contact, a fixed terminal, a coil, an iron core, and a spool. The fixed terminal includes a contact support portion on which the fixed contact is provided. The coil is disposed so that a central axis of the coil extends in the front-rear direction. The coil is disposed behind the fixed terminal. The iron core includes a shaft portion and a head portion. The shaft portion is disposed within the coil and extends in the front-rear direction. The head portion is connected to the front end of the shaft portion. The coil is wound around the spool. The spool includes a hole and a flange. The shaft portion is disposed in the hole. The flange includes a first front surface and a second front surface. The hole is open at the first front surface. The first front surface is disposed rearward of and facing the head portion. The second front surface is disposed rearward of and facing the contact support portion. The second front surface is spaced a predetermined distance rearward from the first front surface. The predetermined distance is greater than the thickness of the contact support portion in the front-rear direction.

In the electromagnetic relay according to the present embodiment, the second front surface is spaced rearward from the first front surface by a distance greater than the thickness of the contact support portion in the front-rear direction. Such a shape of the spool flange makes it possible to arrange the fixed terminal in a compact manner while increasing the insulation distance between the iron core and the fixed terminal in the front-rear direction. This improves the insulation between the iron core and the fixed terminal while preventing the electromagnetic relay from becoming too large.

The entire contact support portion may be located rearward of the first front surface. In this case, the insulation distance between the iron core and the fixed terminal increases in the front-rear direction. This improves the insulation between the iron core and the fixed terminal while preventing the electromagnetic relay from becoming too large.

The entire contact support portion may be located rearward of the head portion. In this case, the insulation distance between the iron core and the fixed terminal increases in the front-rear direction. This improves the insulation between the iron core and the fixed terminal while preventing the electromagnetic relay from becoming too large.

The flange may include a third front surface disposed around the first front surface. The third front surface may be located rearward of the first front surface. In this case, the spool is made smaller. This prevents the electromagnetic relay from becoming too large.

The second front surface may be located rearward of the third front surface. In this case, the insulation distance between the iron core and the fixed terminal increases in the front-rear direction. This improves the insulation between the iron core and the fixed terminal while preventing the electromagnetic relay from becoming too large.

The fixed terminal may include a locking portion. The flange may include a support portion to which the locking portion is attached. The support portion may protrude forward from the third front surface. In this case, the spool is made smaller in size, but the fixed terminal is stably supported by the support portion.

The electromagnetic relay may further include a movable contact, a movable piece, and an armature. The movable contact may be disposed to face the fixed contact. The movable contact may be provided on the movable piece. The armature may be attached to the movable piece. The contact support portion may be located below the head portion. The armature may be attracted to the iron core by electromagnetic force generated by the coil, so that the armature comes into contact with the head portion below the central axis. In this case, a large contact pressure between the movable contact and the fixed contact is ensured.

### BRIEF DESCRIPTION OF THE DRAWINGS

FIG. 1 is a perspective view of an embodiment of an electromagnetic relay in accordance with the claimed invention.

FIG. 2 is a perspective view of the embodiment of an electromagnetic relay in accordance with the claimed invention.

FIG. 3 is a side view of the electromagnetic relay.

FIG. 4 is a cross-sectional side view of the electromagnetic relay.

FIG. 5 is a perspective view of the electromagnetic relay with a common terminal, a movable piece, and an armature omitted.

FIG. 6 is an exploded perspective view of a spool and a base.

FIG. 7 is a perspective view of a first fixed terminal.

FIG. 8 is an enlarged view of a portion of FIG. 4.

FIG. 9 is a perspective view of the electromagnetic relay from below, with the common terminal, the movable piece, and the armature omitted.

FIG. 10 is a perspective view of a second fixed terminal.

FIG. 11 is a cross-sectional top view of the electromagnetic relay.

FIG. 12 is an enlarged side view of a portion of the electromagnetic relay.

FIG. 13 is an enlarged side view of a portion of the electromagnetic relay.

### DETAILED DESCRIPTION

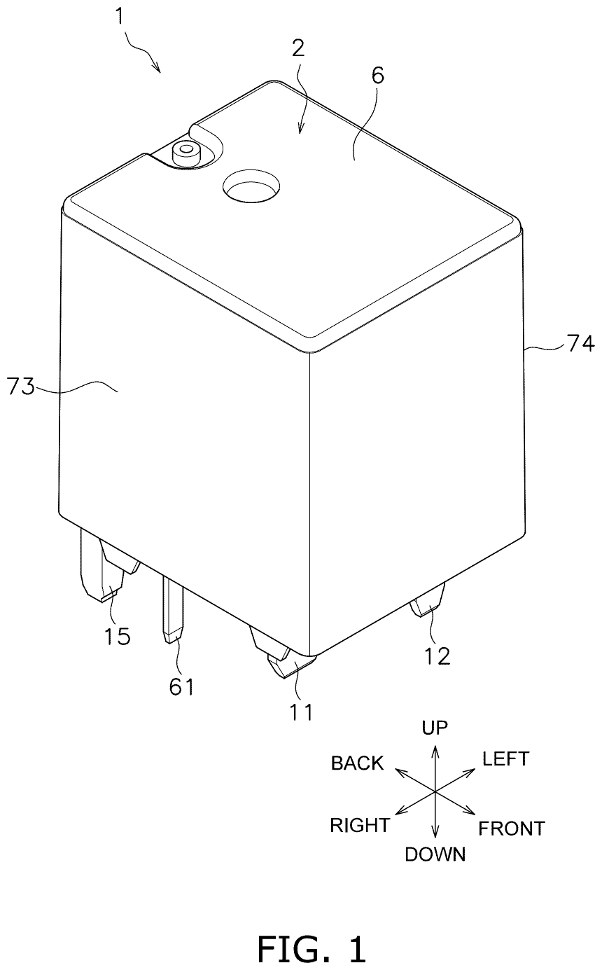

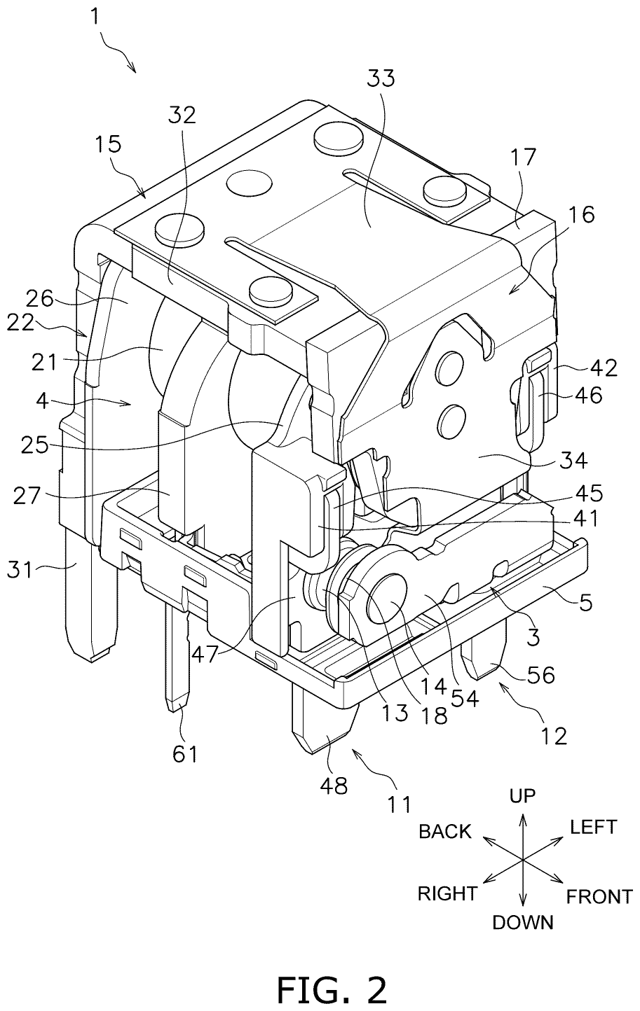

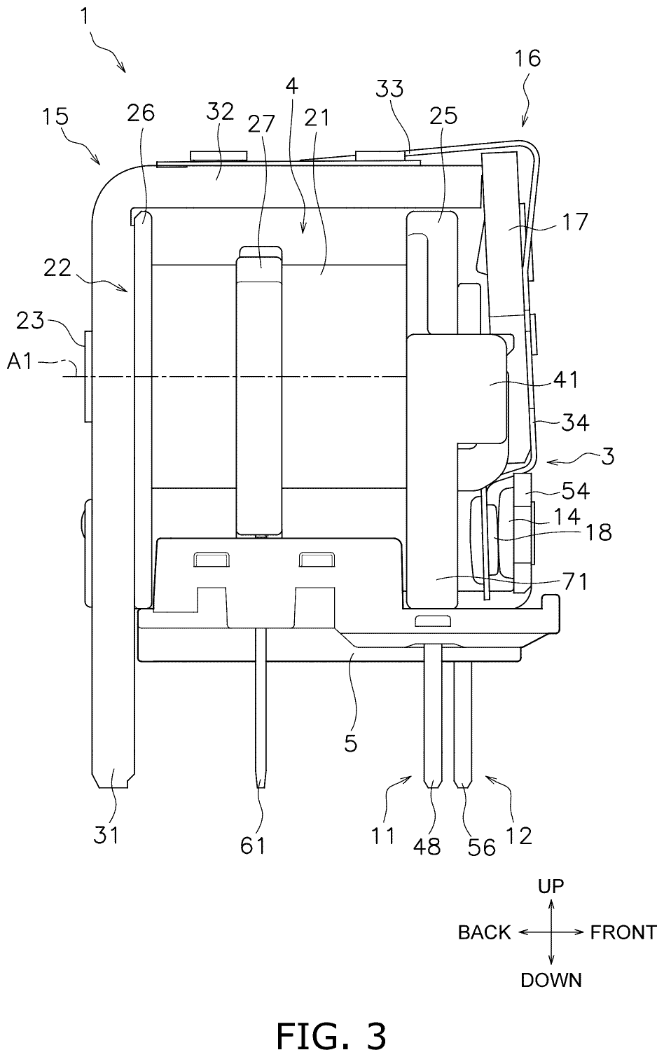

Hereinafter, an electromagnetic relay according to an embodiment will be described with reference to the drawings. FIGS. 1 and 2 are perspective views of an embodiment of an electromagnetic relay 1 in accordance with the claimed invention. FIG. 3 is a side view of the electromagnetic relay 1. As shown in FIGS. 1 to 3, the electromagnetic relay 1 includes a housing 2, a contact device 3, and a drive device 4. The contact device 3 and the drive device 4 are disposed within the housing 2.

The housing 2 includes a base 5 and a case 6. The base 5 supports the drive device 4. The case 6 is attached to the base 5 and covers the drive device 4 and the contact device 3. The base 5 and the case 6 are made of an insulating material such as resin. Alternatively, the base 5 and case 6 may be made of other insulating materials, such as ceramic. It should be noted that the case 6 is omitted in FIGS. 2 and 3.

The contact device 3 includes a first fixed terminal 11, a second fixed terminal 12, a first fixed contact 13, a second fixed contact 14, a common terminal 31, a movable piece 16, an armature 17, and a movable contact 18. The first fixed terminal 11, the second fixed terminal 12, the first fixed contact 13, the second fixed contact 14, the movable contact 18, the common terminal 31, and the movable piece 16 are made of a conductive metal. The armature 17 is made of a magnetic material.

In the following description, the direction in which the second fixed contact 14 is disposed relative to the first fixed contact 13 is defined as the “front”, and the opposite direction is defined as the “rear”. The direction in which the contact device 3 and the drive device 4 are disposed with respect to the base 5 is defined as “upper”, and the opposite direction is defined as “lower”. Additionally, the left and right directions facing forward are defined as “left” and “right”, respectively. However, these directions are defined for the convenience of explanation and do not limit the direction in which the electromagnetic relay 1 is used.

The drive device 4 operates the contact device 3 by electromagnetic force. The drive device 4 includes a coil 21, a spool 22, a yoke 15, and an iron core 23. The coil 21 is wound around a spool 22. The spool 22 is supported by the base 5. As shown in FIG. 3, the spool 22 and the coil 21 are disposed so that the central axis A1 of the coil 21 is aligned with the front-rear direction. The spool 22 is made of an insulating material such as resin. The iron core 23 is connected to the yoke 15.

The spool 22 includes a first flange 25, a second flange 26, and a central flange 27. The first flange 25, the second flange 26, and the central flange 27 protrude in the radial direction of the coil 21. The first flange 25 is located at the front end of the spool 22. The second flange 26 is located at the rear end of the spool 22. The central flange 27 is disposed between the first flange 25 and the second flange 26 in the front-rear direction. The first flange 25 faces the first fixed terminal 11. The second flange 26 faces the common terminal 31. The central flange 27 is disposed between the first fixed terminal 11 and the common terminal 31.

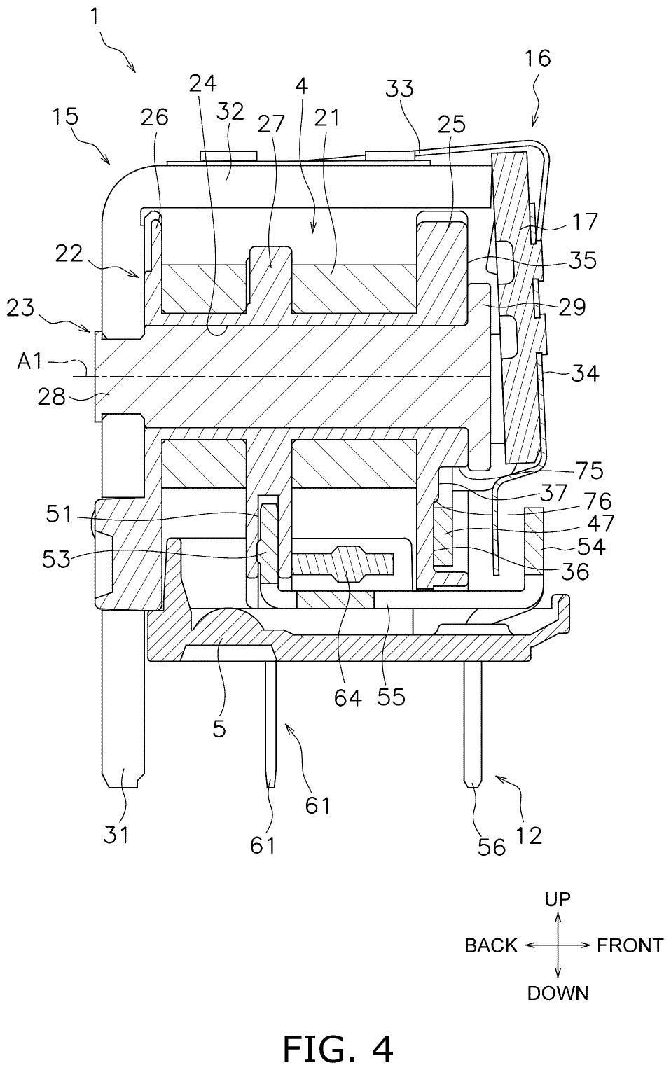

FIG. 4 is a cross-sectional side view taken along the central axis A1 of the coil 21. As shown in FIG. 4, the spool 22 includes a hole 24. The hole 24 extends in the front-rear direction. The iron core 23 includes a shaft portion 28 and a head portion 29. The shaft portion 28 extends in the front-rear direction and is disposed within the hole 24 of the spool 22. The head portion 29 is connected to the front end of the shaft portion 28. The head portion 29 has a larger outer diameter than the shaft portion 28. The head portion 29 is disposed in front of the first flange 25.

A portion of the first fixed terminal 11 protrudes from the base 5 to the exterior of the electromagnetic relay 1. The first fixed terminal 11 is supported by the spool 22. The first fixed terminal 11 is disposed in front of the coil 21. The first fixed terminal 11 is disposed in front of the first flange 25. The first fixed terminal 11 is attached to the first flange 25. The first fixed contact 13 is provided on the first fixed terminal 11.

A portion of the second fixed terminal 12 protrudes from the base 5 to the exterior of the electromagnetic relay 1. The second fixed terminal 12 is supported by the spool 22. The second fixed terminal 12 is disposed in front of the coil 21. The second fixed terminal 12 is disposed in front of the first fixed terminal 11. The second fixed terminal 12 is attached to the central flange 27. The second fixed contact 14 is provided on the second fixed terminal 12.

A portion of the common terminal 31 protrudes from the base 5 to the exterior of the electromagnetic relay 1. The common terminal 31 is integrated with the yoke 15. The common terminal 31 is supported by the spool 22 via the yoke 15. The common terminal 31 is disposed behind the coil 21. The common terminal 31 is disposed behind the second flange 26. The common terminal 31 is attached to the second flange 26 via the yoke 15.

The common terminal 31 extends in the vertical direction. The lower end of the common terminal 31 protrudes downward from the base 5. The yoke 15 extends upward from the common terminal 31 and has an L-shaped bent shape. The yoke 15 includes a horizontal portion 32. The horizontal portion 32 extends in the front-rear direction. The horizontal portion 32 is disposed above the spool 22. The horizontal portion 32 is disposed above the first flange 25, the second flange 26, and the central flange 27.

The movable piece 16 is connected to the common terminal 31 via the yoke 15. The movable contact 18 is provided on the movable piece 16. The movable piece 16 has a spring property. The movable piece 16 includes a leaf spring portion 33 and a movable support portion 34. The movable piece 16 has a bent shape between the leaf spring portion 33 and the movable support portion 34. The leaf spring portion 33 is disposed above the horizontal portion 32 of the yoke 15. The leaf spring portion 33 is fixed to the horizontal portion 32. The movable support portion 34 is disposed in front of the spool 22. The movable support portion 34 extends in the vertical direction. The lower portion of the movable support portion 34 is disposed between the first fixed terminal 11 and the second fixed terminal 12. The movable contact 18 is provided at the lower portion of the movable support portion 34. The movable contact 18 is disposed between the first fixed terminal 11 and the second fixed terminal 12 in the front-rear direction.

The armature 17 is attached to the movable piece 16. The armature 17 is disposed in front of the spool 22. The armature 17 is disposed between the movable support portion 34 of the movable piece 16 and the iron core 23. The armature 17 is disposed to face the head portion 29 of the iron core 23. The armature 17 is attached to the movable support portion 34. The upper portion of the armature 17 is in contact with the horizontal portion 32 of the yoke 15.

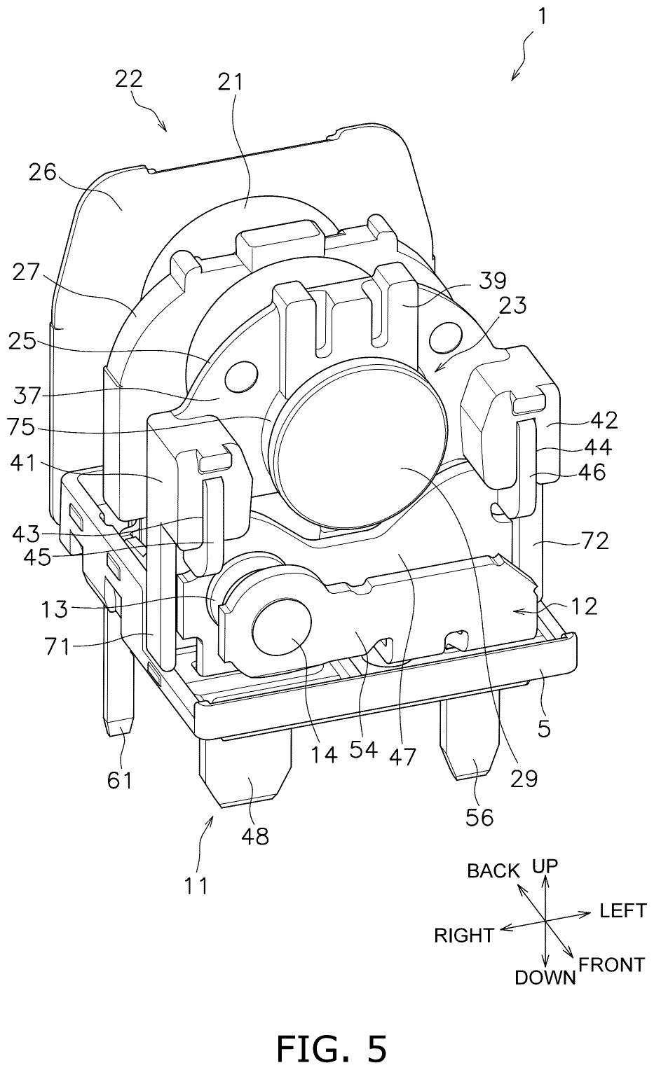

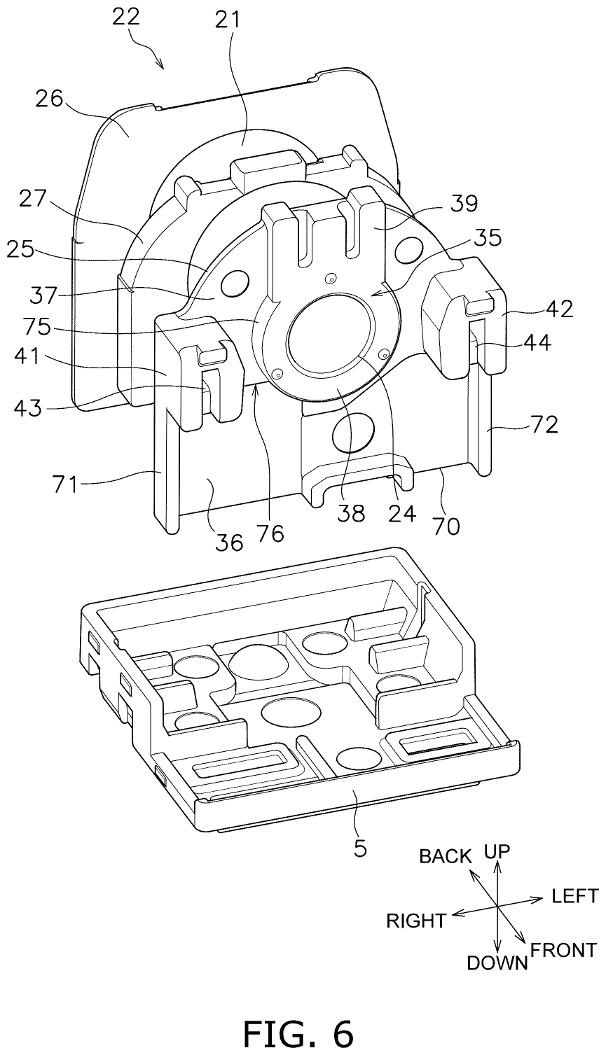

FIG. 5 is a perspective view of the electromagnetic relay 1 with the case 6, the yoke 15, the movable piece 16, and the armature 17 omitted. FIG. 6 is an exploded perspective view of the spool 22 and the base 5. As shown in FIGS. 5 and 6, the first flange 25 includes a first front surface 35, a second front surface 36, and a third front surface 37. The hole 24 opens at the first front surface 35. The hole 24 extends rearward from the first front surface 35. As shown in FIG. 4, the first front surface 35 is disposed rearward of the head portion 29 and facing the head portion 29. The first front surface 35 includes an annular portion 38 and an extension portion 39. The annular portion 38 has a substantially circular shape that matches the outer shape of the head portion 29 described above. The extension portion 39 extends upward from the annular portion 38.

The second front surface 36 is disposed below the first front surface 35. The second front surface 36 extends in the left-right direction. The second front surface 36 is disposed rearward of the first front surface 35. The third front surface 37 is disposed around the first front surface 35. The third front surface 37 is located rearward of the first front surface 35. A first step portion 75 is provided between the third front surface 37 and the first front surface 35. The first step portion 75 protrudes forward from the third front surface 37. The second front surface 36 is located rearward of the third front surface 37. A second step portion 76 is provided between the second front surface 36 and the third front surface 37. The second step portion 76 protrudes forward from the third front surface 37.

The spool 22 includes a first support portion 41 and a second support portion 42. The first support portion 41 is provided on the first flange 25. The first support portion 41 and the second support portion 42 are formed integrally with the first flange 25. The first support portion 41 and the second support portion 42 support the first fixed terminal 11.

The first support portion 41 protrudes forward from the first flange 25. The first support portion 41 protrudes forward from the third front surface 37. The first support portion 41 is disposed to the right of the hole 24 of the spool 22. The first support portion 41 supports the first fixed terminal 11. The first support portion 41 is located at the same height as the central axis A1 of the coil 21. The upper end of the first support portion 41 is located above the central axis A1 of the coil 21. The first support portion 41 includes a first groove 43. The first groove 43 extends in the up-down direction in the first support portion 41.

The second support portion 42 is disposed apart from the first support portion 41 in the left-right direction. The second support portion 42 is provided on the first flange 25. The second support portion 42 protrudes forward from the first flange 25. The second support portion 42 protrudes forward from the third front surface 37. The second support portion 42 is disposed to the left of the hole 24 of the spool 22. The second support portion 42 supports the first fixed terminal 11. The second support portion 42 is located at the same height as the central axis A1 of the coil 21. The upper end of the second support portion 42 is located above the central axis A1 of the coil 21. The second support portion 42 includes a second groove 44. The second groove 44 extends in the up-down direction in the second support portion 42.

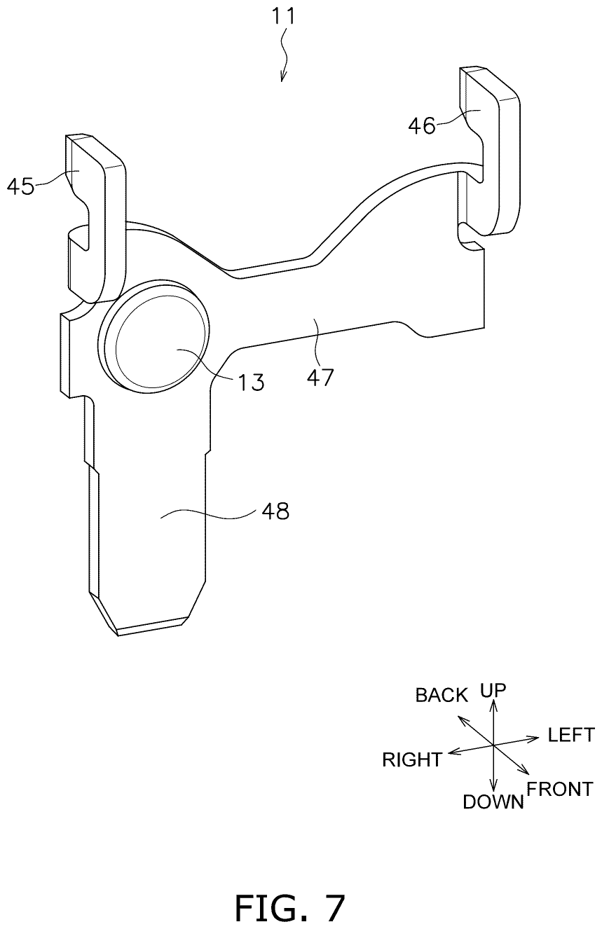

FIG. 7 is a perspective view of the first fixed terminal 11. As shown in FIG. 7, the first fixed terminal 11 includes a first locking portion 45, a second locking portion 46, a first contact support portion 47, and a first external terminal portion 48. The first locking portion 45 extends in the front-rear direction and the up-down direction. The first locking portion 45 is press-fitted into the first groove 43. The first fixed terminal 11 is thereby attached to the first support portion 41. The second locking portion 46 extends in the front-rear direction and the up-down direction. The second locking portion 46 is press-fitted into the second groove 44. The first fixed terminal 11 is thereby attached to the second support portion 42.

The first contact support portion 47 extends in the left-right direction. The first contact support portion 47 connects the first locking portion 45 and the second locking portion 46. The first fixed contact 13 is provided on the first contact support portion 47. The first external terminal portion 48 extends downward from the first contact support portion 47. The first external terminal portion 48 protrudes from the base 5 to the exterior of the electromagnetic relay 1.

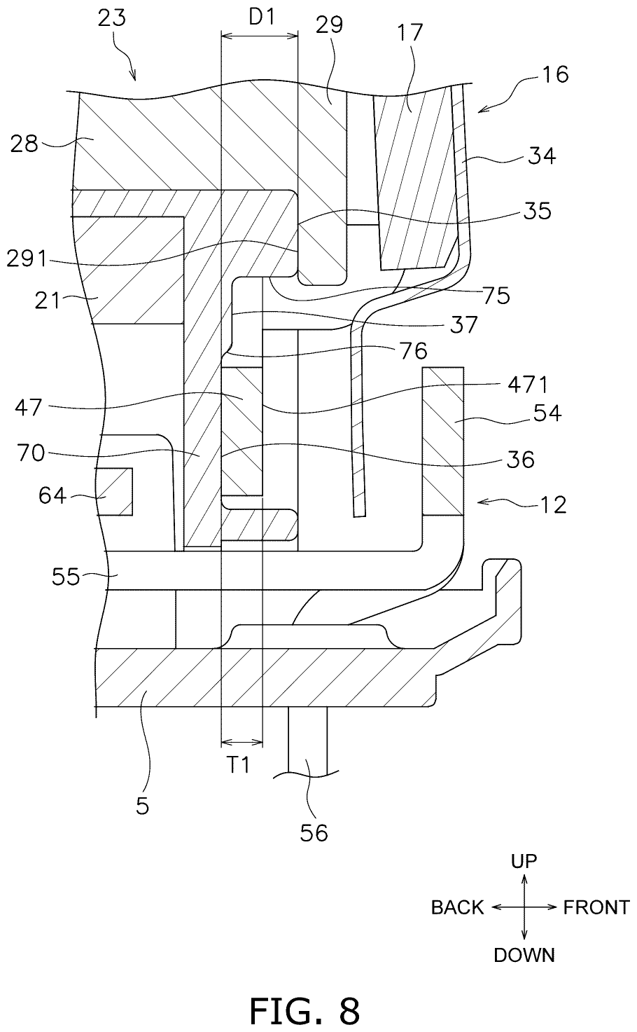

FIG. 8 is an enlarged view of a portion of FIG. 4. As shown in FIG. 8, the first contact support portion 47 is disposed below the head portion 29. The entire first contact support portion 47 is disposed rearward of the first front surface 35 of the first flange 25. The entire first contact support portion 47 is located rearward of the head portion 29. In particular, the front surface 471 of the first contact support portion 47 is located rearward of the first front surface 35. The front surface 471 of the first contact support portion 47 is located rearward of the rear surface 291 of the head portion 29.

The first contact support portion 47 is disposed below the first step portion 75 and the second step portion 76 to face the first step portion 75 and the second step portion 76. The second front surface 36 is disposed rearward of the first contact support portion 47 and faces the first contact support portion 47. The second front surface 36 is disposed rearward of the first front surface 35 at a predetermined distance D1. The predetermined distance D1 is greater than the thickness Tl of the first contact support portion 47 in the front-rear direction.

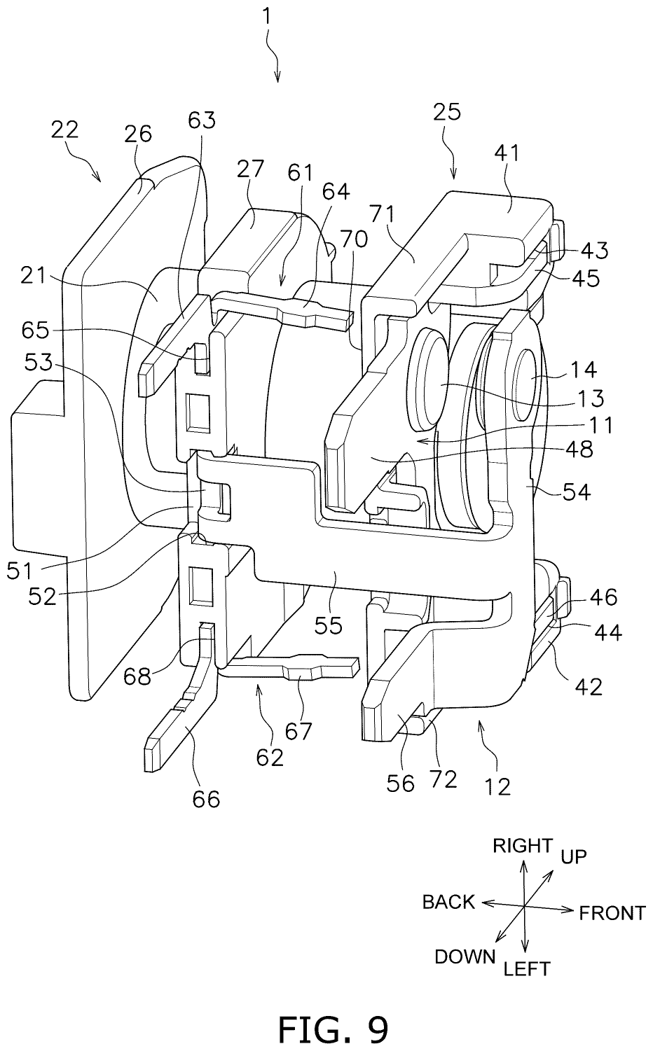

FIG. 9 is a perspective view of the electromagnetic relay 1 from below, with the housing 2, the yoke 15, the movable piece 16, and the armature 17 omitted. As shown in FIG. 9, the spool 22 includes a third support portion 51. The third support portion 51 is provided on the central flange 27. The third support portion 51 supports the second fixed terminal 12. The third support portion 51 includes a third groove 52. The third groove 52 is provided on the bottom surface of the central flange 27.

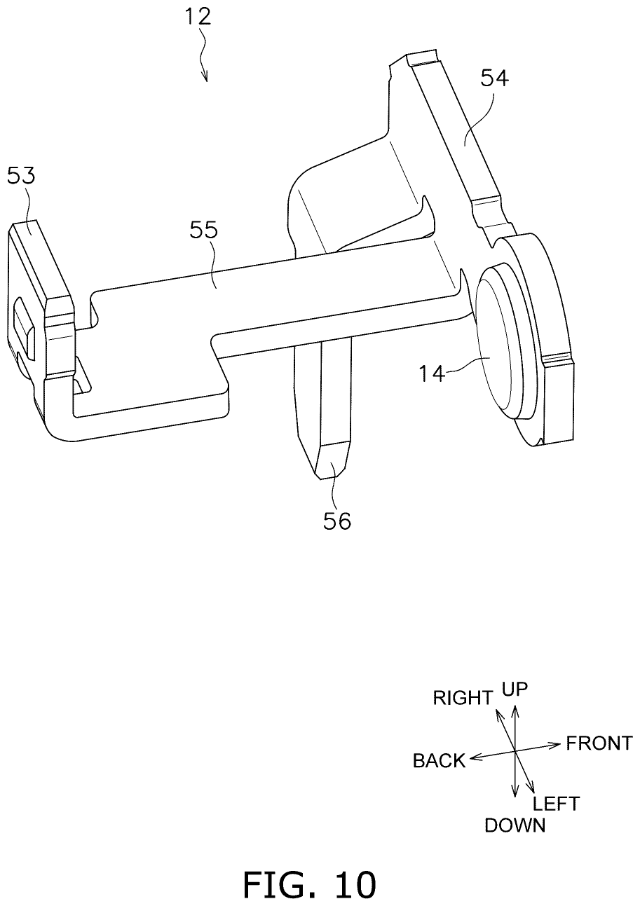

FIG. 10 is a perspective view of the second fixed terminal 12. As shown in FIG. 10, the second fixed terminal 12 includes a third locking portion 53, a second contact support portion 54, a connecting portion 55, and a second external terminal portion 56. The third locking portion 53 extends in the up-down direction. The third locking portion 53 is press-fitted into the third groove 52. The second fixed terminal 12 is thereby attached to the third support portion 51. The second contact support portion 54 extends in the left-right direction. The second fixed contact 14 is provided on the second contact support portion 54. The connecting portion 55 extends in the front-rear direction. The connecting portion 55 connects the third locking portion 53 and the second contact support portion 54 together. The second external terminal portion 56 extends downward from the second contact support portion 54. The second external terminal portion 56 protrudes from the base 5 to the exterior of the electromagnetic relay 1.

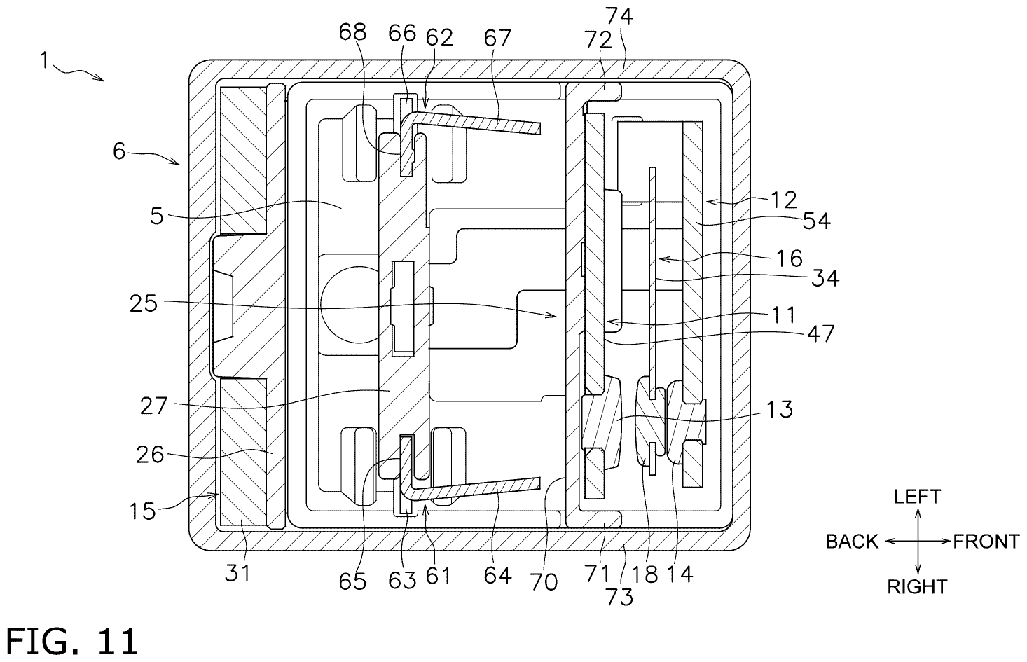

FIG. 11 is a cross-sectional top view of the electromagnetic relay 1. As shown in FIGS. 9 and 11, the electromagnetic relay 1 includes a first coil terminal 61 and a second coil terminal 62. The first coil terminal 61 and the second coil terminal 62 are connected to the coil 21. The first coil terminal 61 and the second coil terminal 62 are attached to the central flange 27. The first coil terminal 61 and the second coil terminal 62 are disposed between the first fixed terminal 11 and the common terminal 31.

The first coil terminal 61 includes a first body portion 63 and a first tie-down portion 64. The first body portion 63 is supported by the central flange 27. The first body portion 63 extends downward from the central flange 27. The first body portion 63 protrudes from the base 5 to the exterior of the electromagnetic relay 1.

The first tie-down portion 64 is formed integrally with the first body portion 63. The first tie-down portion 64 is bent relative to the first body portion 63. The first tie-down portion 64 extends forward from the first body portion 63 along the axial direction of the coil 21. The first tie-down portion 64 extends from the first body portion 63 toward the first flange 25. The first tie-down portion 64 extends from the first body portion 63 toward the first fixed terminal 11. A first end of the coil 21 is wound around the first tie-down portion 64 to secure and electrically connect that end of the coil 21 to the first coil terminal 61.

The second coil terminal 62 has a similar shape to the first coil terminal 61. The second coil terminal 62 is disposed away from the first coil terminal 61 in the left-right direction. The second coil terminal 62 includes a second body portion 66 and a second tie-down portion 67. The second body portion 66 and the second tie-down portion 67 have the same shapes as the first body portion 63 and the first tie-down portion 64, respectively. A second end of the coil 21 is wound around the second tie-down portion 67 to secure and electrically connect that second end of the coil 21 to the second coil terminal 62.

As shown in FIG. 9, the central flange 27 includes a fourth groove 65 and a fifth groove 68. The fourth groove 65 and the fifth groove 68 are disposed to the left and right of the third groove 52. The first body portion 63 is press-fitted into the fourth groove 65. The first coil terminal 61 is thereby attached to the central flange 27. The second body portion 66 is press-fitted into the fifth groove 68. The second coil terminal 62 is thereby attached to the central flange 27.

As shown in FIG. 6, the first flange 25 includes a vertical wall portion 70, a first lateral wall portion 71, and a second lateral wall portion 72. The vertical wall portion 70 extends in the left-right direction. The vertical wall portion 70 extends upward from the base 5. The vertical wall portion 70 is disposed behind the first fixed terminal 11. The vertical wall portion 70 is disposed between the first fixed terminal 11 and the first tie-down portion 64. The vertical wall portion 70 is disposed between the first fixed terminal 11 and the second tie-down portion 67. The second front surface 36 mentioned above is the front surface of the vertical wall portion 70.

The first lateral wall portion 71 is bent relative to the vertical wall portion 70. The first lateral wall portion 71 protrudes forward from the second front surface 36. The first lateral wall portion 71 is disposed laterally outward of the first contact support portion 47 of the first fixed terminal 11. The first lateral wall portion 71 covers the first contact support portion 47 from the laterally outer side. In a side view, the first lateral wall portion 71 overlaps with the first contact support portion 47. The first lateral wall portion 71 is disposed laterally outward of the first fixed contact 13. The first lateral wall portion 71 covers the first fixed contact 13 from the laterally outer side. In a side view, the first lateral wall portion 71 overlaps the first fixed contact 13. The first lateral wall portion 71 is disposed at a non-overlapping position with the second contact support portion 54 in a side view. The first lateral wall portion 71 is disposed at a non-overlapping position with the second fixed contact 14 in a side view. The first lateral wall portion 71 extends forward from the vertical wall portion 70.

As shown in FIG. 3, the first lateral wall portion 71 extends downward from the first support portion 41. The first lateral wall portion 71 is shorter than the first support portion 41 in the front-rear direction. That is, the first support portion 41 is longer than the first lateral wall portion 71 in the front-rear direction.

As shown in FIG. 11, the case 6 includes a first side surface 73 and a second side surface 74. The first side surface 73 and the second side surface 74 are disposed apart from each other in the left-right direction. The first side surface 73 covers the first fixed terminal 11 and the second fixed terminal 12 from the right side. The second side surface 74 covers the first fixed terminal 11 and the second fixed terminal 12 from the left side. The first lateral wall portion 71 is disposed between the first fixed terminal 11 and the first side surface 73. In particular, the first lateral wall portion 71 is disposed between the first contact support portion 47 and the first side surface 73 of the first fixed terminal 11.

The second lateral wall portion 72 has the same shape as the first lateral wall portion 71. The second lateral wall portion 72 is disposed symmetrically to the first lateral wall portion 71. The vertical wall portion 70 and the first lateral wall portion 71 described above increase the insulation distance between the first coil terminal 61 and the first fixed terminal 11. In addition, the vertical wall portion 70 and the second lateral wall portion 72 provide an insulation distance between the second coil terminal 62 and the first fixed terminal 11.

In the electromagnetic relay 1 according to the above-described embodiment, the electromagnetic relay 1 operates when electricity is applied to the coil 21 via the first coil terminal 61 and the second coil terminal 62. The operation of the electromagnetic relay 1 will now be described.

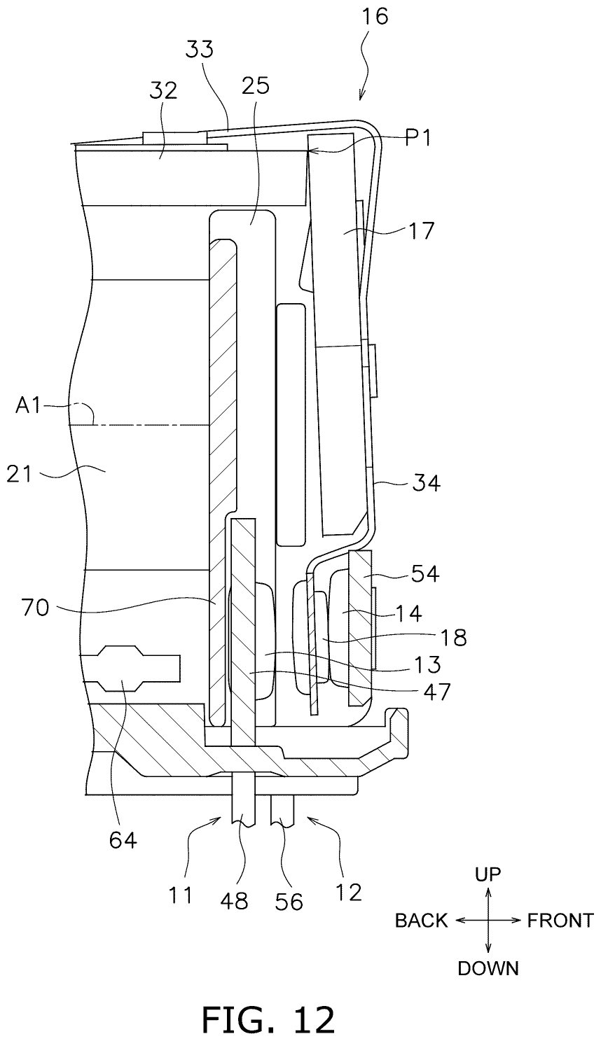

In the electromagnetic relay 1, when the coil 21 is not energized, as shown in FIG. 12, the elastic force of the contact piece keeps the armature 17 away from the iron core 23 and urges the movable contact 18 toward the second fixed contact 14. As a result, the movable contact 18 is separated from the first fixed contact 13 and is in contact with the second fixed contact 14.

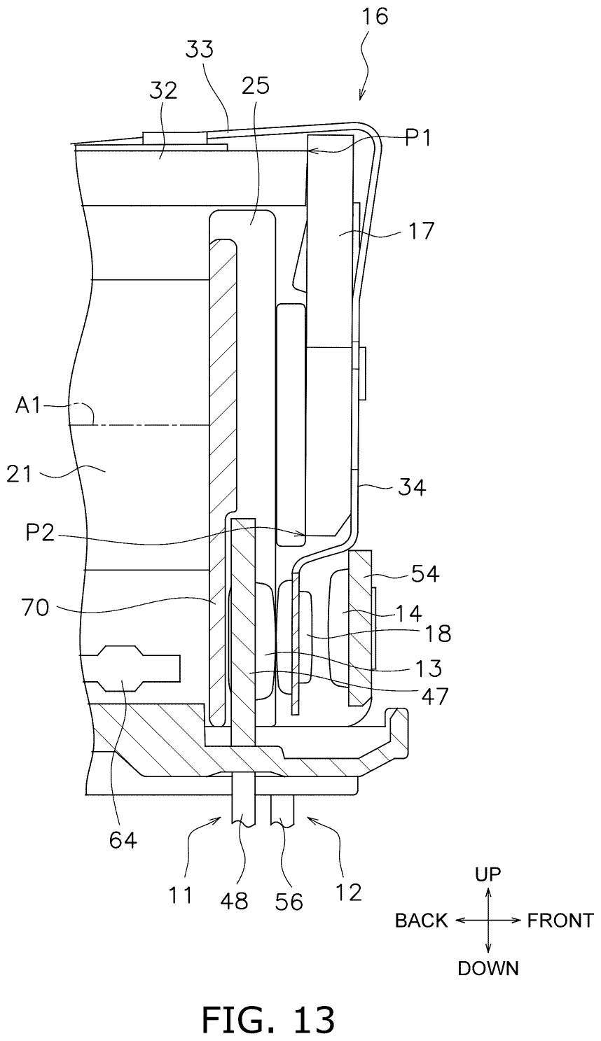

When the coil 21 is energized, the magnetic field generated by the coil 21 generates a magnetic force, which attracts the armature 17 to the iron core 23. As a result, the armature 17 rotates around a support position P1 by the horizontal portion 32 and comes into contact with the head portion 29 at a contact position P2, as shown in FIG. 13. The contact position P2 is located below the central axis A1. This movement of the armature 10) 17 causes the movable piece 16 to deform elastically, and the movable support portion 34 moves toward the first fixed terminal 11. As a result, the movable contact 18 moves away from the second fixed contact 14 and comes into contact with the first fixed contact 13.

When the current supply to the coil 21 is turned off, the elastic force of the movable piece 16 causes the movable support portion 34 to move toward the second fixed contact 14. As a result, the armature 17 moves away from the iron core 23. As a result, as shown in FIG. 12, the movable contact 18 moves away from the first fixed contact 13 and comes into contact with the second fixed contact 14.

In the electromagnetic relay 1 according to the embodiment described above, the second front surface 36 of the first flange 25 is spaced rearward from the first front surface 35 by a distance greater than the thickness Tl of the first contact support portion 47 in the front-rear direction. Such a shape of the first flange 25 makes it possible to arrange the first fixed terminal 11 compactly while increasing the insulation distance between the iron core 23 and the first fixed terminal 11 in the front-rear direction. This improves the insulation between the iron core 23 and the first fixed terminal 11 while preventing the electromagnetic relay 1 from becoming too large.

Although one embodiment of the claimed invention has been described above, the claimed invention is not limited to the above embodiment, and various modifications are possible without departing from the scope of the claimed invention.

The shapes of the first fixed terminal 11, the second fixed terminal 12, and the common terminal 31 are not limited to those in the above embodiment and may be modified. The shape of the movable piece 16 is not limited to that in the above embodiment and may be changed. The shapes of the base 5 and the case 6 are not limited to those in the above embodiment and may be modified. The second fixed contact 14 of the second fixed terminal 12 may be omitted. In that case, the second external terminal portion 56 may be omitted, and the second fixed terminal 12 may be used as a dummy terminal. The common terminal 31 may not be integrated with the yoke 15 but may be separate therefrom.

The common terminal 31 may be integrated with the movable piece 16.

The shape of the spool 22 is not limited to that in the above embodiment and may be modified. For example, the second fixed terminal 12 may be supported by the first flange 25. The shape of the first lateral wall portion 71 is not limited to that in the above embodiment and may be modified. The shape of the second lateral wall portion 72 may also be changed in the same manner as the first lateral wall portion 71.

### REFERENCE SIGNS LIST

11: First fixed terminal, 13: First fixed contact, 16: Movable piece, 17: Armature, 18: Movable contact, 21: Coil, 23: Iron core, 24: Hole, 25: First flange, 28: Shaft portion, 29: Head portion, 22: Spool, 35: First front surface, 36: Second front surface, 37: Third front surface, 45: First locking portion, 41: First support portion, 47: First contact support portion

1. An electromagnetic relay, comprising:
a fixed contact;
a fixed terminal including a contact support portion on which the fixed contact is provided;
a coil disposed behind the fixed terminal and having a central axis extending in a front-rear direction of the electromagnetic relay;
an iron core including a shaft portion disposed within the coil and extending in the front-rear direction and a head portion connected to a front end of the shaft portion; and
a spool around which the coil is wound,
wherein the spool includes
a hole in which the shaft portion is disposed,
a flange including a first front surface at which the hole is open and which is disposed rearward of the head portion to face the head portion, and a second front surface which is spaced rearward from the first front surface by a predetermined distance and which is disposed rearward of the contact support portion to face the contact support portion, and
the predetermined distance is greater than a thickness of the contact support portion in the front-rear direction.

2. The electromagnetic relay according to claim 1, wherein the entire contact support portion is located rearward of the first front surface.

3. The electromagnetic relay according to claim 1, wherein the entire contact support portion is located rearward of the head portion.

4. The electromagnetic relay according to claim 1, wherein the flange further includes a third front surface disposed around the first front surface and the third front surface is located rearward of the first front surface.

5. The electromagnetic relay according to claim 4, wherein the second front surface is located rearward of the third front surface.

6. The electromagnetic relay according to claim 4, wherein the fixed terminal includes a locking portion, the flange includes a support portion to which the locking portion is attached, and the support portion protrudes forward from the third front surface.

7. The electromagnetic relay according to claim 1, further comprising:
a movable contact disposed to face the fixed contact;
a movable piece on which the movable contact is provided; and
an armature attached to the movable piece,
wherein the contact support portion is disposed below the head portion, and
the armature is attracted to the iron core by an electromagnetic force generated by the coil when the coil is energized so that the armature comes into contact with the head portion below the central axis.
